(19) United States
(12) Patent Application Publication
(10) Pub. No.: US 2025/0266218 A1
(43) Pub. Date: Aug. 21, 2025

(54) RELAY

(71) Applicant: Panasonic Intellectual Property Management Co., Ltd., Osaka (JP)

(72) Inventors: TAEHO JANG, Hokkaido (JP); SATOSHI SAKAI, Mie (JP)

(21) Appl. No.: 18/859,341

(22) PCT Filed: Apr. 19, 2023
(86) PCT No.: PCT/JP2023/015610

§ 371 Date: Oct. 23, 2024

(30) Foreign Application Priority Data
May 12, 2022 (CN) 202210518738.1

(51) Int. Cl. H01H 9/44; H01H 50/54

(52) U.S. Cl. CPC H01H 9/443; H01H 50/54

(57) ABSTRACT

A relay includes a first fixed terminal including a first fixed contact, a second fixed terminal positioned on left of the first fixed terminal and including a second fixed contact, a movable contactor including a first projection that comes into contact with or is separated from the first fixed contact, and a first magnet facing the movable contactor. The first magnet is provided on a right side of a right end of the movable contactor, the first projection overlaps the first fixed contact in top view, and a right end of the first fixed contact is positioned on a left side of the right end of the movable contactor and on a right side of a right end of the first projection.

### TECHNICAL FIELD

The present invention relates generally to a relay.

### BACKGROUND ART

A relay described in PTL 1 includes a contact portion including two movable contacts and two fixed contacts. The movable contacts and the fixed contacts come into contact with or are separated from each other.

In such a relay, when the movable contacts and the fixed contacts are separated from each other, an arc generated between the movable contacts and the fixed contacts may directly extend from left and right end surfaces of the movable contacts in a direction perpendicular to the left and right end surfaces. That is, a direction in which the arc is extended is parallel to a magnetic flux direction of a magnet.

Thus, since the Lorentz force necessary for extending the arc cannot be sufficiently secured, extinction of the arc may become difficult.

### CITATION LIST

### Patent Literature

PTL 1: Unexamined Japanese Patent Publication No. 2021-051978

### SUMMARY OF THE INVENTION

The present invention includes a first fixed terminal including a first fixed contact, a second fixed terminal positioned on a left side of the first fixed terminal and including a second fixed contact, a movable contactor including a first projection that comes into contact with or is separated from the first fixed contact, and a first magnet facing the movable contactor.

Here, the first magnet is provided on a right side of a right end of the movable contactor. In addition, the first projection overlaps the first fixed contact in top view. Then, a right end of the first fixed contact is positioned to a left side of the right end of the movable contactor and on a right side of a right end of the first projection.

According to the present invention, arc-extinguishing capability of the relay can be improved.

### BRIEF DESCRIPTION OF THE DRAWINGS

FIG. 1 is a plan view of a relay according to an exemplary embodiment of the present invention.

FIG. 2 is a side view of the relay according to the exemplary embodiment of the present invention.

FIG. 3 is a sectional view of the relay according to the exemplary embodiment of the present invention taken along line A-A in FIG. 1.

FIG. 4 is a sectional view of the relay according to the exemplary embodiment of the present invention taken along line A-A in FIG. 1.

FIG. 5 is a perspective view of a movable contactor of the relay according to the exemplary embodiment of the present invention.

FIG. 6 is a sectional view of the relay according to the exemplary embodiment of the present invention taken along line B-B in FIG. 2.

### DESCRIPTION OF EMBODIMENT

### Exemplary Embodiment

An exemplary embodiment of the present invention will be described with reference to the drawings. Note that, for the sake of convenience in description, up-down, left-right, and front-rear directions are illustrated in the drawings, and these directions do not limit directions when a device is attached and used at all.

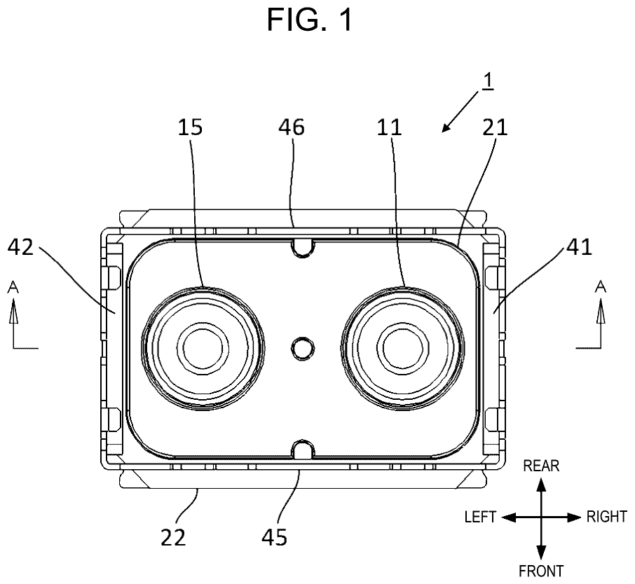

As illustrated in FIGS. 1 to 4, relay 1 according to the exemplary embodiment of the present invention includes first fixed terminal 11, second fixed terminal 15, housing 21, movable contactor 30, first magnet 41, second magnet 42, and movable shaft 51.

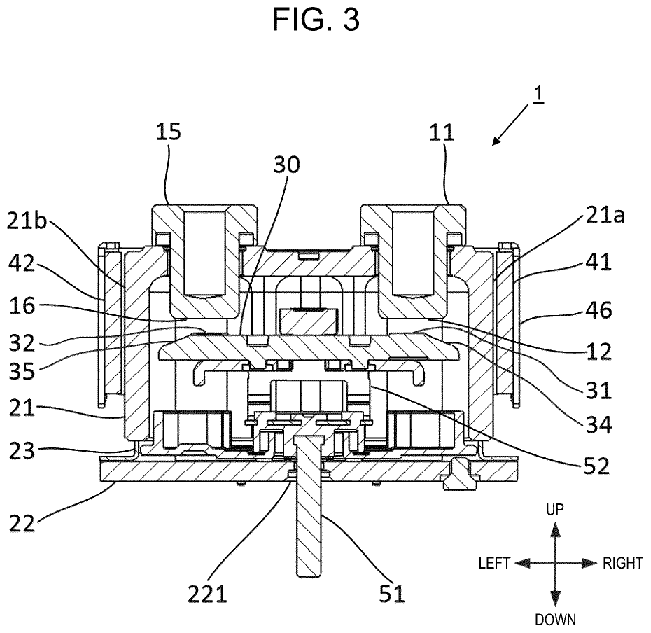

As illustrated in FIGS. 1 and 3, first fixed terminal 11 is made of a conductive material such as copper, has a substantially columnar shape, and is fixed to an upper surface of housing 21. An upper end of first fixed terminal 11 is exposed to an outside of housing 21, and a lower end of first fixed terminal 11 is inserted into housing 21. A lower end surface of first fixed terminal 11 includes first fixed contact 12 that comes into contact with or is separated from first projection 31 of movable contactor 30 to be described later.

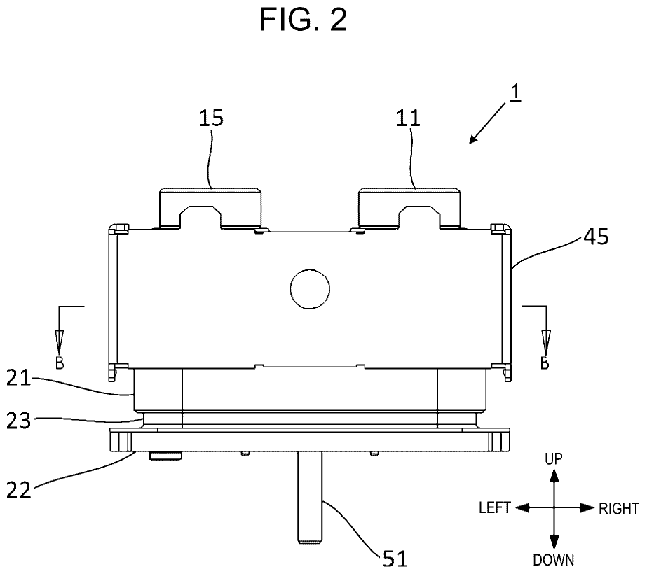

FIG. 6 is a sectional view of relay 1 according to the exemplary embodiment of the present invention taken along line B-B in FIG. 2. In FIG. 6, projections of first fixed contact 12 and second fixed contact 16 are indicated by a shaded circular region with a dotted boundary. As illustrated in FIG. 6, first fixed contact 12 overlaps movable contactor 30 in plan view. Here, the “plan view” means viewing from above. An outer edge of first fixed contact 12 is positioned inside an outer edge of movable contactor 30 in plan view. Here, the “first fixed contact 12 overlaps movable contactor 30 in plan view” means that first fixed contact 12 and movable contactor 30 are projected on a horizontal plane perpendicular to a direction in plan view, and both the projections at least partially overlap each other. Similarly, “A and B overlap” described in the following description means that A and B are projected on a plane perpendicular to an observation direction, and projections of A and B at least partially overlap each other.

As illustrated in FIGS. 1 and 3, second fixed terminal 15 is disposed on a left side of first fixed terminal 11. First fixed terminal 11 and second fixed terminal 15 are disposed in a line in the left-right direction. Second fixed terminal 15 is made of a conductive material such as copper and has a substantially columnar shape. Second fixed terminal 15 is fixed to an upper wall portion of housing 21, and has an upper end exposed to an outside of housing 21 and a lower end inserted into housing 21. A lower end surface of second fixed terminal 15 includes second fixed contact 16 that comes into contact with or is separated from second projection 32 and/or third projection 33 of movable contactor 30 to be described later. In addition, as illustrated in FIG. 6, second fixed contact 16 overlaps movable contactor 30 when looking down, and an outer edge of second fixed contact 16 is positioned inside an outer edge of movable contactor 30 when looking down.

As illustrated in FIGS. 1 to 3, housing 21 is made of a heat resistant material such as ceramic and is a rectangular box opened downward, and includes an upper wall portion and a peripheral wall portion. Movable contactor 30 is housed in housing 21, and housing 21 covers movable contactor 30. First fixed terminal 11 and second fixed terminal 15 are inserted into housing 21. Housing 21 is positioned between first magnet 41 and second magnet 42. A lower opening of housing 21 is closed by bottom plate 22, and through-hole 221 through which movable shaft 51 passes is provided at a center of bottom plate 22. In order to enhance sealability between housing 21 and bottom plate 22, coupling flange 23 is provided between housing 21 and bottom plate 22.

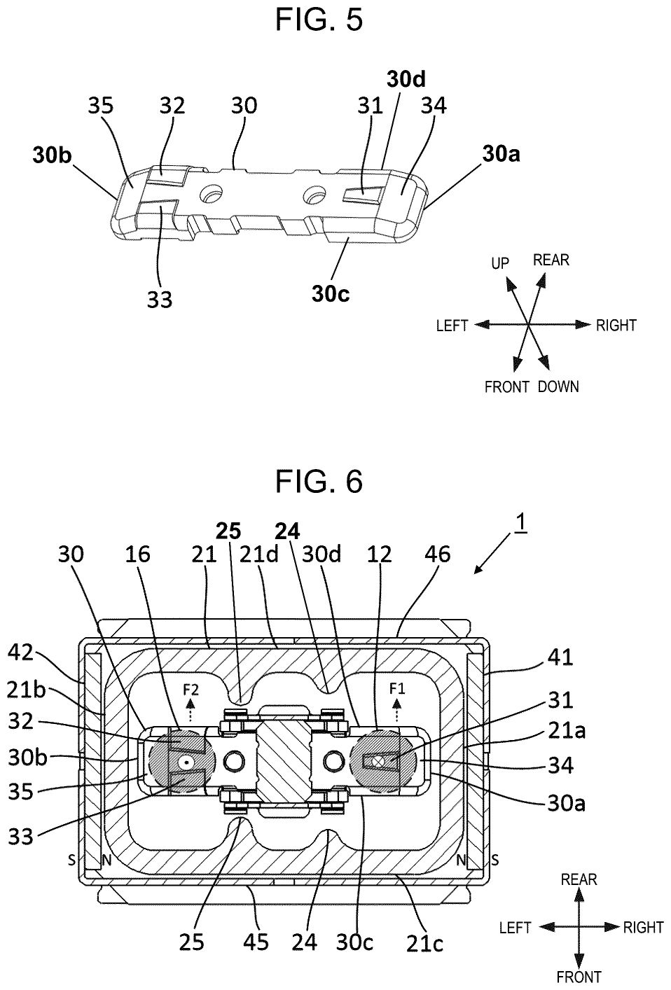

As illustrated in FIGS. 5 and 6, movable contactor 30 is made of a conductive material such as copper. A length of movable contactor 30 is larger than a width of movable contactor 30. That is, a distance from right end portion 30a to left end portion 30b of movable contactor 30 is longer than a distance from one side surface 30c to other side surface 30d of movable contactor 30. In addition, a width of movable contactor 30 is larger than a thickness of movable contactor 30.

First projection 31 protruding upward is provided on an upper surface of movable contactor 30. A shape of first projection 31 in plan view is a substantially trapezoidal shape symmetrical with respect to a center line of movable contactor 30 in the left-right direction, and a width of first projection 31 in the front-rear direction increases from left to right. First projection 31 comes into contact with or is separated from first fixed contact 12. That is, first projection 31 has a first movable contact. In other words, movable contactor 30 has first projection 31 that comes into contact with or is separated from first fixed contact 12.

Further, movable contactor 30 further includes first base 34 positioned on a right side of first projection 31. First projection 31 protrudes upward from first base 34. Thus, a distance between first projection 31 and first fixed terminal 11 is smaller than a distance between first base 34 and first fixed terminal 11.

An upper surface of first base 34 is an inclined surface that is inclined downward toward right end portion 30a of movable contactor 30. The distance between first base 34 and first fixed terminal 11 increases toward right end portion 30a of movable contactor 30. Thus, an arc is gradually extended as the arc moves on first base 34 toward right end portion 30a.

Further, first projection 31 and first base 34 are preferably connected by a side surface formed as a smooth curved surface of first projection 31. As a result, the arc generated by first projection 31 can easily move toward first base 34.

In addition, movable contactor 30 includes second projection 32 and third projection 33 disposed in parallel with second projection 32. Each of second projection 32 and third projection 33 overlaps second fixed contact 16 in plan view. Second projection 32 and third projection 33 are provided on the upper surface of movable contactor 30 and are in a line in the front-rear direction. A current flows through movable contactor 30 in the left-right direction. Accordingly, the front-rear direction is a direction orthogonal to a direction in which the current flows through movable contactor 30. That is, second projection 32 and third projection 33 are in a line in the direction orthogonal to the direction in which the current flows through movable contactor 30.

Second projection 32 and third projection 33 have a substantially right-angled trapezoidal shape in plan view, and oblique sides thereof face each other in the front-rear direction. As a result, a shortest distance (that is, a distance in the front-rear direction) between second projection 32 and third projection 33 increases toward a left end of movable contactor 30. Second projection 32 and third projection 33 have second movable contacts coming into contact with second fixed contact 16.

Movable contactor 30 comes into contact with first fixed terminal 11 and second fixed terminal 15 at three points when relay 1 is closed by providing first projection 31 as the first movable contactor and providing second projection 32 and third projection 33 as the second movable contacts in movable contactor 30. With this configuration, in a state where movable contactor 30 cones into contact with first fixed terminal 11 and second fixed terminal 15, movable contactor 30 is prevented from rattling.

Note that, it is not essential that second fixed contact 16 comes into contact with both second projection 32 and third projection 33, and for example, second fixed contact 16 may come into contact with either second projection 32 or third projection 33.

Further, movable contactor 30 has second base 35 positioned on a left side of second projection 32. Second projection 32 protrudes upward from second base 35.

A distance between second projection 32 and second fixed terminal 15 is smaller than a distance between second base 35 and second fixed terminal 15. An upper surface of second base 35 is an inclined surface that is inclined downward toward left end portion 30b of movable contactor 30. Thus, the distance between second base 35 and second fixed terminal 15 increases toward left end portion 30b of movable contactor 30. Thus, an arc is gradually extended as the arc moves on second base 35 toward left end portion 30b.

Further, second projection 32 and second base 35 are preferably connected by a side surface formed as a smooth curved surface of second projection 32. As a result, the arc generated by second projection 32 can easily move from second projection 32 toward second base 35. Similarly, third projection 33 and second base 35 are preferably connected by a side surface formed as a smooth curved surface of third projection 33. With this configuration, the arc generated by third projection 33 can easily move from third projection 33 toward second base 35.

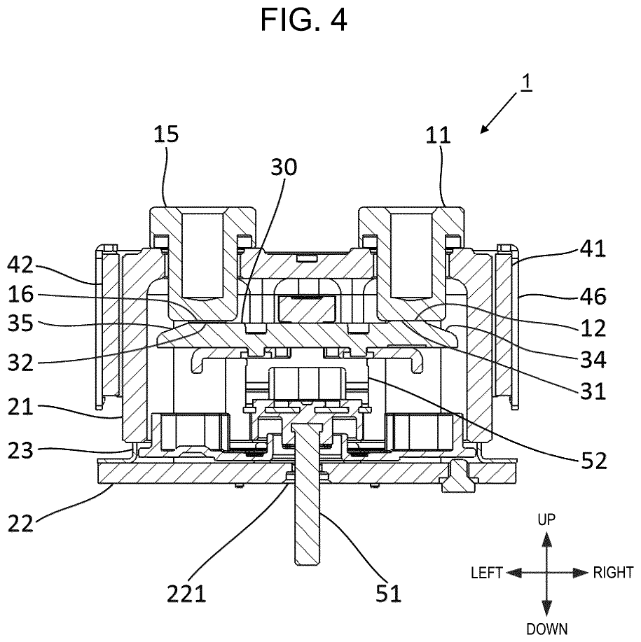

As illustrated in FIGS. 3 and 4, movable contactor 30 is held by holder 52 at an upper end of movable shaft 51, moves up and down along with movement of movable shaft 51 up and down, and can move between an opened position and a closed position. In FIG. 3, movable contactor 30 is positioned at the opened position, and this state may be referred to as an “opened state”. In FIG. 4, movable contactor 30 is positioned at the closed position, and this state may be referred to as a “closed state”.

Specifically, when an electromagnetic body is energized, movable shaft 51 moves upward, and movable contactor 30 moves upward. Thus, an upper surface of first projection 31 comes into contact with first fixed contact 12, and upper surfaces of second projection 32 and third projection 33 come into contact with second fixed contact 16. Movable contactor 30 moves upward, and thus, first fixed terminal 11 and second fixed terminal 15 are electrically connected to each other (see FIG. 4).

FIG. 4 illustrates a state where relay 1 is switched to the closed position. When the energization to the electromagnetic body is stopped, movable shaft 51 moves downward by an action of a recovery spring, and movable contactor 30 moves downward. First projection 31 is separated from first fixed contact 12, and second projection 32 and third projection 33 are separated from second fixed contact 16. As a result, first fixed terminal 11 and second fixed terminal 15 are switched from the electrical connection state to an electrical disconnection state. In FIG. 3, relay 1 is switched to an electrical disconnection position illustrated in FIG. 3.

As illustrated in FIGS. 3 and 6, first magnet 41 is provided on a right side of housing 21, and second magnet 42 is provided on a left side of housing 21. First magnet 41 and second magnet 42 are provided to face each other in the front-rear direction. First magnet 41 and second magnet 42 are held by substantially U-shaped first holder 45 and second holder 46, respectively.

Here, first magnet 41 is held on an outer surface of right side wall 21a of housing 21, and second magnet 42 is held on an outer surface of left side wall 21b of housing 21. First magnet 41 and second magnet 42 are arrayed such that identical poles face each other. For example, in a case where N poles are arrayed to face each other, a left side surface of first magnet 41 is the N pole, a right side surface thereof is an S pole, a right side surface of second magnet 42 is the N pole, and a left side surface thereof is the S pole. Note that, identical poles of first magnet 41 and second magnet 42 may not face each other.

First magnet 41 is, for example, a permanent magnet such as a ferrite magnet or a neodymium magnet. First magnet 41 is provided on a right side of a right end of movable contactor 30 and faces movable contactor 30. In addition, first magnet 41 is disposed to overlap movable contactor 30 as viewed from a right side, and a width of first magnet 41 in the front-rear direction is preferably larger than a width of movable contactor 30 in the front-rear direction.

In addition, a height of first magnet 41 in the up-down direction is preferably larger than a distance between first fixed contact 12 and first projection 31 when movable contactor 30 is in the opened position.

In this configuration, first magnet 41 generates a magnetic flux from right to left in a space between first fixed contact 12 and first projection 31.

Second magnet 42 is, for example, a permanent magnet such as a ferrite magnet or a neodymium magnet. Second magnet 42 is provided on a left side of a left end of movable contactor 30 and faces movable contactor 30. In addition, second magnet 42 is disposed to overlap movable contactor 30 as viewed from a left side, and a width of second magnet 42 in the front-rear direction is preferably larger than a width of movable contactor 30 in the front-rear direction.

In addition, a height of second magnet 42 in the up-down direction is preferably larger than a distance between second fixed contact 16 and second projection 32 and a distance between second fixed contact 16 and third projection 33 when movable contactor 30 is in the opened position.

In this configuration, second magnet 42 generates a magnetic flux from left to right in a space between second fixed contact 16 and second projection 32 and a space between second fixed contact 16 and third projection 33.

As illustrated in FIG. 6, when movable contactor 30 moves downward from the closed position to the opened position, an arc is generated between first fixed contact 12 and first projection 31, and an arc is also generated between second fixed contact 16, second projection 32, and third projection 33.

The Lorentz force acting on the generated arc in a case where the current flows from first fixed terminal 11 side toward second fixed terminal 15 side when relay 1 is at the closed position will be described.

On first fixed terminal 11 side, the current flows from upward to downward from first fixed contact 12 toward first projection 31. In addition, first magnet 41 generates a magnetic flux from right to left in a space between first fixed contact 12 and first projection 31. Thus, Lorentz force F1 directed rearward acts on the arc generated between first fixed contact 12 and first projection 31.

In addition, on second fixed terminal 15 side, the current flows from downward to upward from second projection 32 and third projection 33 toward second fixed contact 16. In addition, second magnet 42 generates a magnetic flux from left to right in a space between second fixed contact 16 and second projection 32 and third projection 33. Thus, Lorentz force F2 directed rearward acts on the arc generated between second fixed contact 16 and second projection 32 or third projection 33.

Note that, the same applies to the Lorentz force acting on the generated arc in a case where the current flows from second fixed terminal 15 side to first fixed terminal 11 side when relay 1 is at the closed position. That is, Lorentz force F1 directed forward acts on the arc generated between first fixed contact 12 and first projection 31. Then, Lorentz force F2 directed forward is generated with respect to the arc generated between second fixed contact 16 and second projection 32 or third projection 33.

As illustrated in FIG. 6, as viewed from above, a distance in the left-right direction between an inner surface of right side wall 21a of housing 21 and right end portion 30a of movable contactor 30 is smaller than a distance in the front-rear direction between an inner surface of front side wall 21c of housing 21 and side surface 30c of movable contactor 30, and is smaller than a distance in the front-rear direction between an inner surface of rear side wall 21d of housing 21 and side surface 30d of movable contactor 30.

That is, a shortest distance between an inner surface of housing 21 and right end portion 30a of movable contactor 30 is shorter than a shortest distance between the inner surface of housing 21 and side surface 30c and a shortest distance between the inner surface of housing 21 and side surface 30d. With this configuration, a space between the inner surface of housing 21 and right end portion 30a of movable contactor 30 is relatively small, and a space between the inner surface of housing 21 and side surfaces 30c and 30d of movable contactor 30 is relatively large.

As a result, it is possible to suppress an increase in size of housing 21 in the left-right direction while securing a space for extending an arc between side surfaces 30c and 30d of movable contactor 30 and the inner surface of housing 21.

In addition, as viewed from above, a distance in the left-right direction between an inner surface of left side wall 21b of housing 21 and left end portion 30b of movable contactor 30 is smaller than a distance in the front-rear direction between the inner surface of front side wall 21c of housing 21 and side surface 30c of movable contactor 30, and is smaller than a distance in the front-rear direction between the inner surface of rear side wall 21d of housing 21 and side surface 30d of movable contactor 30.

That is, a shortest distance between the inner surface of housing 21 and left end portion 30b of movable contactor 30 is shorter than a shortest distance between the inner surface of housing 21 and side surface 30c and a shortest distance between the inner surface of housing 21 and side surface 30d. With this configuration, a space between the inner surface of housing 21 and left end portion 30b of movable contactor 30 is relatively small, and a space between the inner surface of housing 21 and side surfaces 30c and 30d of movable contactor 30 is relatively large.

As a result, it is possible to suppress an increase in size of housing 21 in the left-right direction while securing a space for extending an arc between side surfaces 30c and 30d of movable contactor 30 and the inner surface of housing 21.

In addition, a pair of first protrusions 24 and a pair of second protrusions 25 are provided on the inner surfaces of front side wall 21c and rear side wall 21d of housing 21 to face each other. First protrusion 24 is positioned on a right side of second protrusion 25, and a protrusion height of first protrusion 24 in the front-rear direction is smaller than a protrusion height of second protrusion 25 in the front-rear direction.

First protrusion 24 can prevent the arc generated on first fixed contact 12 side from propagating to second fixed contact 16 side, and second protrusion 25 can prevent the arc generated on second fixed contact 16 side from propagating to first fixed contact 12 side. In addition, second protrusion 25 can also restrict the rotation of movable contactor 30 by abutting on movable contactor 30 or holder 52.

As illustrated in FIG. 6, as viewed from above, first projection 31 overlaps first fixed contact 12, and first projection 31 is completely covered by first fixed contact 12. In addition, a right end of first fixed contact 12 is positioned on a left side of the right end of movable contactor 30 and is positioned on a right side of a right end of first projection 31. As a result, a distance by which the arc moves can be secured between the right end of first projection 31 and the right end (right end portion 30a) of movable contactor 30.

Specifically, a case where the current flows from first fixed terminal 11 to second fixed terminal 15 when relay 1 is in the closed state will be described as an example. When movable contactor 30 moves from the closed position to the opened position, an arc is generated at a contact portion between first fixed contact 12 and first projection 31, and the arc moves along the upper surface of movable contactor 30 with first projection 31 as a start point.

Since a movable distance of the arc generated between the right end (right end portion 30b) of first projection 31 and the right end of movable contactor 30 is set, the arc moving toward right end portion 30a of movable contactor 30 can be suppressed.

Here, when the arc extends rightward from right end portion 30a of movable contactor 30, a direction in which the arc extends and a direction of the magnetic flux of first magnet 41 are substantially parallel, and the Lorentz force is less likely to act on the arc. As a result, the arc is less likely to be extinguished. In addition, in a case where the space between the inner surface of housing 21 and right end portion 30a of movable contactor 30 is relatively small, it is difficult to further extend the arc and extinguish the arc.

On the other hand, when the configuration of the present invention is used, the generated arc moves toward side surface 30d of movable contactor 30 and is extended rearward from side surface 30d of movable contactor 30. Thus, a relatively large Lorentz force easily acts on the arc, and the arc is easily extinguished.

In addition, in a case where the space between the inner surface of housing 21 and side surface 30d of movable contactor 30 is larger than the space between the inner surface of housing 21 and right end portion 30a of movable contactor 30, the arc is more easily extended, and thus, the arc is more easily extinguished.

As viewed from above, second projection 32 and third projection 33 overlap second fixed contact 16. In addition, a left end of second fixed contact 16 is positioned on a right side of the left end of movable contactor 30 and is positioned on a left side of left ends of second projection 32 and third projection 33. As a result, it is possible to secure the distance by which the arc moves between the left end of second projection 32 and the left end (left end portion 30b) of movable contactor 30 and between the left end of third projection 33 and the left end (left end portion 30b) of movable contactor 30.

Specifically, a case where the current flows from first fixed terminal 11 to second fixed terminal 15 when movable contactor 30 of relay 1 is in the closed state will be described as an example. When movable contactor 30 moves from the closed position to the opened position, an arc is generated between a contact portion between second fixed contact 16 and second projection 32 or between a contact portion between second fixed contact 16 and third projection 33. The arc moves along the upper surface of movable contactor 30 starting from second projection 32 or third projection 33. Since the distance by which the arc moves is set between second projection 32 and the left end (left end portion 30b) of movable contactor 30 or between the left end of third projection 33 and the left end (left end portion 30b) of movable contactor 30, the arc moving toward left end portion 30b of movable contactor 30 can be suppressed.

Here, when the arc extends leftward from left end portion 30b of movable contactor 30, a direction in which the arc extends and a direction of the magnetic flux of second magnet 42 are substantially parallel, and the Lorentz force is less likely to act on the arc. As a result, the arc is less likely to be extinguished. In addition, in a case where the space between the inner surface of housing 21 and left end portion 30b of movable contactor 30 is relatively small, the arc is further extended and the arc is hardly extinguished.

On the other hand, when the structure of the present invention is used, the generated arc moves toward side surface 30d of movable contactor 30 and is extended rearward from side surface 30d of movable contactor 30. Thus, a relatively large Lorentz force is easily generated in the arc, and the arc is easily extinguished.

In addition, in a case where the space between the inner surface of housing 21 and side surface 30d of movable contactor 30 is larger than the space between the inner surface of housing 21 and right end portion 30a of movable contactor 30, the arc is more easily extended, and thus, the arc is more easily extinguished.

In addition, the upper surface of first base 34 is formed as the inclined surface. Thus, even though movable contactor 30 is inclined in the left-right direction when the movable contactor moves from the closed position to the opened position, the distance between first projection 31 and first fixed terminal 11 is smaller than the distance between first base 34 and first fixed terminal 11.

In addition, the upper surface of second base 35 is formed as the inclined surface. Thus, even though movable contactor 30 is inclined in the left-right direction when the movable contactor moves from the closed position to the opened position, the distance between second projection 32 and second fixed terminal 15 and the distance between third projection 33 and second fixed terminal 15 are smaller than the distance between second base 35 and second fixed terminal 15.

Accordingly, the arc easily moves along the upper surface of movable contactor 30 starting from first projection 31, second projection 32, and third projection 33, and the movement distance of the arc can be further secured.

Note that, although it has been described that the arc moving toward side surface 30d of movable contactor 30 is extended rearward from side surface 30d of movable contactor 30, the arc may move toward side surface 30c of movable contactor 30 and may extend forward from side surface 30c of movable contactor 30 by changing magnetic poles of first magnet 41 and second magnet 42 and an orientation of the current flowing when relay 1 is in the closed state.

The exemplary embodiment of the present invention has been described in detail above. However, the above-described exemplary embodiment is not intended to limit the present invention. The present invention also includes modifications in which various changes devised by those skilled in the art are applied to the above-described exemplary embodiment without departing from the meaning of the words described in the claims.

For example, in the above-described exemplary embodiment, although second projection 32 and third projection 33 are provided in movable contactor 30, second projection 32 and third projection 33 may be one projection such as first projection 31.

In addition, for example, in the above-described exemplary embodiment, although first projection 31 is provided on movable contactor 30, another projection disposed in parallel with first projection 31 may be provided to form two or more projections such as second projection 32 and third projection 33.

For example, in the above-described exemplary embodiment, the upper surfaces of first base 34 and second base 35 may not be the inclined surfaces inclined downward, but may be flat surfaces aligned with upper surfaces of other portions of movable contactor 30, for example.

Relay 1 described above can improve arc-extinguishing capability.

### REFERENCE MARKS IN THE DRAWINGS

1 relay
11 first fixed terminal
12 first fixed contact
15 second fixed terminal
16 second fixed contact
21 housing
21a right side wall
21b left side wall
21c front side wall
21d rear side wall
22 bottom plate
221 through-hole
23 coupling flange
24 first protrusion
25 second protrusion
30 movable contactor
30a right end portion
30b left end portion
30c side surface
30d side surface
31 first projection
32 second projection
33 third projection
34 first base
35 second base
41 first magnet
42 second magnet
45 first holder
46 second holder
51 movable shaft
52 holder

1. A relay comprising:
a first fixed terminal including a first fixed contact;
a second fixed terminal positioned on left of the first fixed terminal and including a second fixed contact;
a movable contactor including a first projection that comes into contact with or is separated from the first fixed contact; and
a first magnet facing the movable contactor,
wherein
the first magnet is provided on a right side of a right end of the movable contactor,
the first projection overlaps the first fixed contact in top view, and
a right end of the first fixed contact is positioned on a left side of the right end of the movable contactor and on a right side of a right end of the first projection.

2. The relay according to claim 1, wherein
a length that is a distance from the right end to a left end of the movable contactor is larger than a width of the movable contactor, and
the first magnet overlaps the movable contactor as viewed from right.

3. The relay according to claim 1, wherein
a left end of the second fixed contact is positioned on a right side of a left end of the movable contactor.

4. The relay according to claim 1, wherein
the first fixed contact overlaps the movable contactor in top view, and
an outer edge of the first fixed contact is positioned inside an outer edge of the movable contactor in top view.

5. The relay according to claim 1, wherein
the movable contactor further includes a first base,
the first base is positioned on a right side of the first projection, and
a distance between the first projection and the first fixed terminal is smaller than a distance between the first base and the first fixed terminal.

6. The relay according to claim 1, wherein
an upper surface of the first projection come into contact with the first fixed contact.

7. The relay according to Claim 1, comprising:
a second magnet facing the movable contactor, wherein
the second magnet is provided on a left side of a left end of the movable contactor, and
the second magnet overlaps the movable contactor as viewed from left.

8. The relay according to claim 7, wherein the first magnet and the second magnet are in a line, and identical poles of the first magnet and the second magnet face each other.

9. The relay according to claim 7, further comprising:
a case that covers the movable contactor, wherein
in top view, a shortest distance between an inner surface of the case and a right end surface of the movable contactor is shorter than a shortest distance between the inner surface of the case and a side surface connecting the right end surface and a left end surface of the movable contactor.

10. The relay according to claim 9, wherein
the first fixed terminal and the second fixed terminal are inserted into the case, and
the case is positioned between the first magnet and the second magnet.

11. The relay according to claim 1 wherein
the movable contactor further includes a second projection, and
the second projection overlaps the second fixed contact in top view.

12. The relay according to claim 11, wherein
the movable contactor further includes a third projection disposed in a line with the second projection,
the third projection overlaps the second fixed contact in top view, and
the second fixed contact comes into contact with or is separated from the second projection or the third projection.

13. The relay according to claim 11, wherein
the movable contactor further includes a third projection disposed in a line with the second projection,
the third projection overlaps the second fixed contact in top view, and
the second fixed contact comes into contact with or is separated from both the second projection and the third projection.

14. The relay according to claim 12, wherein
the second projection and the third projection are positioned on an upper surface of the movable contactor, and are in a line in the movable contactor in a direction orthogonal to a direction in which a current flows.

15. The relay according to claim 12, wherein
a shortest distance between the second projection and the third projection increases toward a left end of the movable contactor.

16. The relay according to claim 5, wherein
an upper surface of the first base is inclined downward toward the right end of the movable contactor.

17. The relay according to claim 11, wherein
the movable contactor further includes a second base,
the second base is positioned on a left side of the second projection,
a distance between the second projection and the second fixed terminal is smaller than a distance between the second base and the second fixed terminal, and
an upper surface of the second base is inclined downward toward a left end of the movable contactor.
